(19) United States
(12) Patent Application Publication
(10) Pub. No.: US 2009/0194230 A1
(43) Pub. Date: Aug. 6, 2009

(54) APPARATUS AND METHOD FOR APPLYING TAX STAMPS

(76) Inventors: Jason L. Brandow, Fort Worth, TX (US); Marc J. Wilson, Byron Center, MI (US); Bruce D. DeBoer, Jenison, MI (US); James S. Rabourn, Caledonia, MI (US); Jack E. Spaans, Sparta, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/329,888

(22) Filed: Dec. 8, 2008

Related U.S. Application Data
(60) Provisional application No. 61/012,254, filed on Dec. 7, 2007.

(51) Int. Cl. B32B 37/02

(52) U.S. Cl. 156/277; 156/352; 156/350

(57) ABSTRACT

A tax stamp apparatus applies labels to individual packages of cigarettes, and prints tax information on the labels after they are applied to cartons of cigarettes. The apparatus may include a digital scanner that scans and decodes two-dimensional bar code information printed on the labels. The tax information may be supplied to the apparatus from a remote location, and the scanned data may be compared to the tax information supplied to the apparatus to verify that the tax indicia have been applied to the cartons of cigarettes.

### CROSS REFERENCE TO RELATED APPLICATION

This application claims the benefit of U.S. Provisional Application No. 61/012,254, filed on Dec. 7, 2007, entitled APPARATUS AND METHOD FOR APPLYING TAX STAMPS, the entire contents of which are incorporated herein by reference.

### BACKGROUND OF THE INVENTION

Various devices have been developed for applying tax information to cartons of cigarettes. Tax information is typically provided in the form of preprinted stamps that are applied to individual packages of cigarettes. Such stamps are often specific to a given date and/or local region. The stamps are typically applied prior to shipment of the cigarettes to the retailer such as a gas station or the like. Also, a given retailer may order a variety of different brands and sizes of cigarettes for a particular shipment.

### SUMMARY OF THE INVENTION

One aspect of the present invention is an apparatus for applying tax stamps to packages of cigarettes. The apparatus may include a support structure and a controller that is adapted to be operably connected to a network (e.g. the internet or other communication systems such as phone systems, satellite communication systems, etc.) to receive tax stamp data from a remote location utilizing the network. A conveyor system is mounted to the support structure for moving cartons of cigarettes along a path defining a downstream direction. A loading system receives cartons of cigarettes to be moved along the conveyor system, and an opening station downstream of the loading station opens cartons of cigarettes moving along the conveyor system. The apparatus may include a device that applies a recordable medium to the packages of cigarettes, such as a label applicator that adhesively applies labels to packages of cigarettes. The labels may be blank (i.e. without tax stamp information) at the time they are applied to the individual packages of cigarettes. The apparatus further includes a data-application station wherein tax stamp information or data is applied to individual packages of cigarettes. The data-application station may comprise a printer mounted to the support structure downstream of the label-applying station. The printer may be operably connected to the controller, and utilize tax stamp data to print tax stamps that may be in the form of two-dimensional (“2D”) bar codes or data matrix codes on the labels that were applied to the cartons of cigarettes at the label-applying station. The apparatus further includes a device that reads or captures the tax stamp data previously applied to the cartons. The device may comprise an optical scanner mounted to the support structure downstream of the data application station that reads the 2D bar codes printed on labels of packages of cigarettes by the printer, and generates data corresponding to the 2D bar codes. The controller compares the tax stamp data read by the optical scanner to the tax stamp data received by the controller from a remote location. The controller may thereby determine if the data from the optical scanner is the same (equivalent) to the supplied data to verify application of the data.

Another aspect of the present invention is an apparatus for applying tax stamps to packages of cigarettes including a conveyor system that moves cartons of cigarettes along a path defining a downstream direction. The apparatus includes a loading station configured to receive cartons of cigarettes to be moved along the conveyor system. The apparatus may include a label-applying station downstream of the loading station having an applicator that removes labels from a carrier strip and adhesively applies the labels to packages of cigarettes. The apparatus further includes a data-application station downstream of the label-applying station. The data-application station may include a printer that prints information on the labels that have been applied to the packages of cigarettes at the label-applying station. An optical device downstream of the printing station generates data corresponding to the information printed on the labels.

Yet another aspect of the present invention is a method of applying information to objects, and verifying the information. The method may include applying information in the form of tax stamps to packages of cigarettes. The method includes generating tax information, and supplying the tax information to an apparatus configured to apply the tax information to packages of cigarettes. The method further includes moving packages of cigarettes through the apparatus along a conveyor, and applying labels to packages of cigarettes. The method also includes printing tax information on the labels after the labels have been applied to packages of cigarettes. After the tax information has been printed on the labels, the tax information is scanned, and the scanned tax information may be compared to the tax information supplied to the apparatus to verify that the tax information has been applied to the packages of cigarettes.

### BRIEF DESCRIPTION OF THE FIGURES

FIG. 1 is an isometric view of a tax stamp apparatus according to one aspect of the present invention;

FIG. 2 is an isometric view of a portion of the tax stamp apparatus of FIG. 1;

FIG. 3 is a partially fragmentary isometric view of a portion of the tax stamp apparatus of FIGS. 1 and 2;

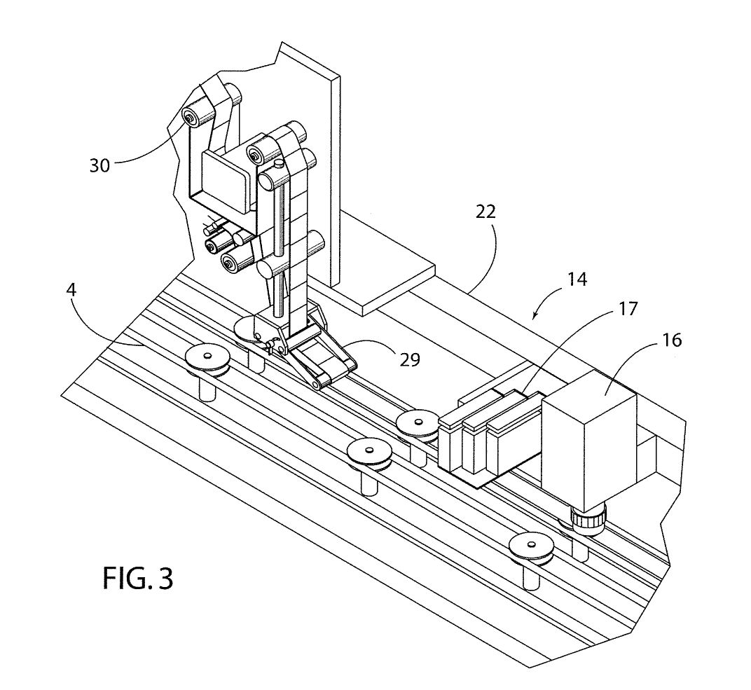

FIG. 4 is an isometric view of a portion of the tax stamp apparatus of FIG. 1;

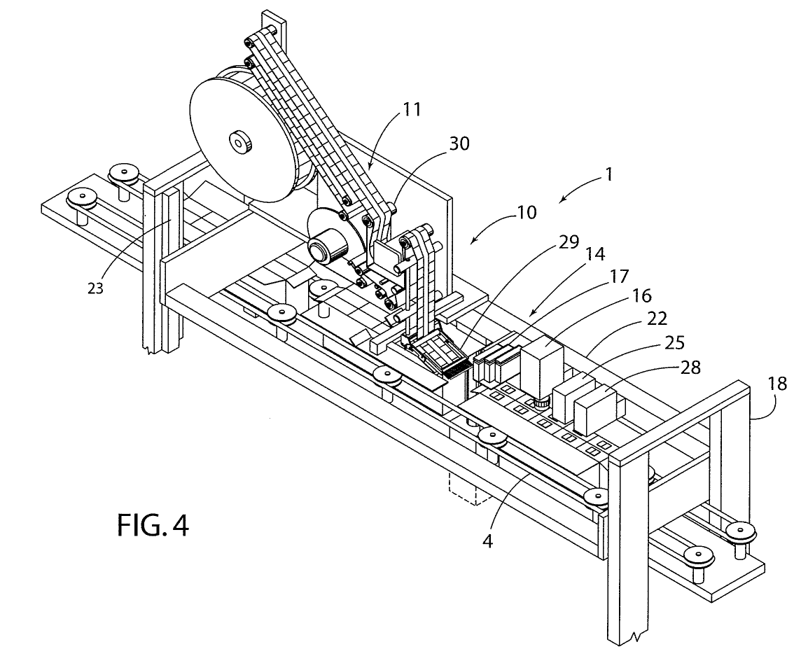

FIG. 5 is a partially fragmentary isometric view showing cartons of cigarettes in the apparatus of FIG. 1;

FIG. 6 is a side elevational view of a portion of the apparatus of FIG. 1; and

FIG. 7 is a diagram showing a system for generating, distributing, and applying tax stamp information.

### DETAILED DESCRIPTION OF PREFERRED EMBODIMENTS

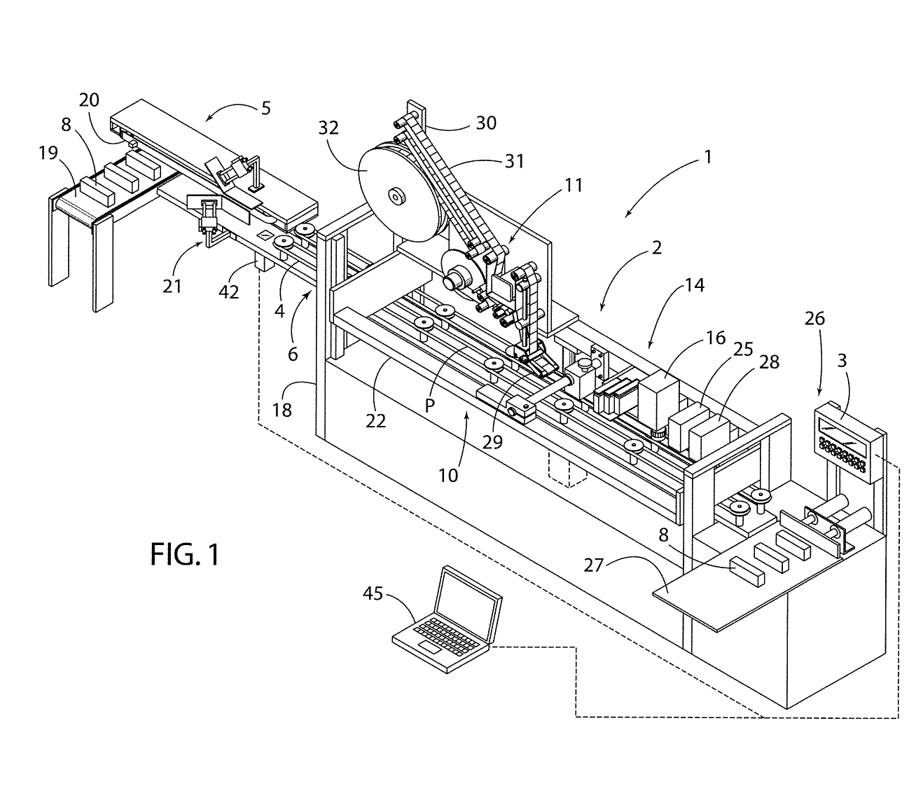

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

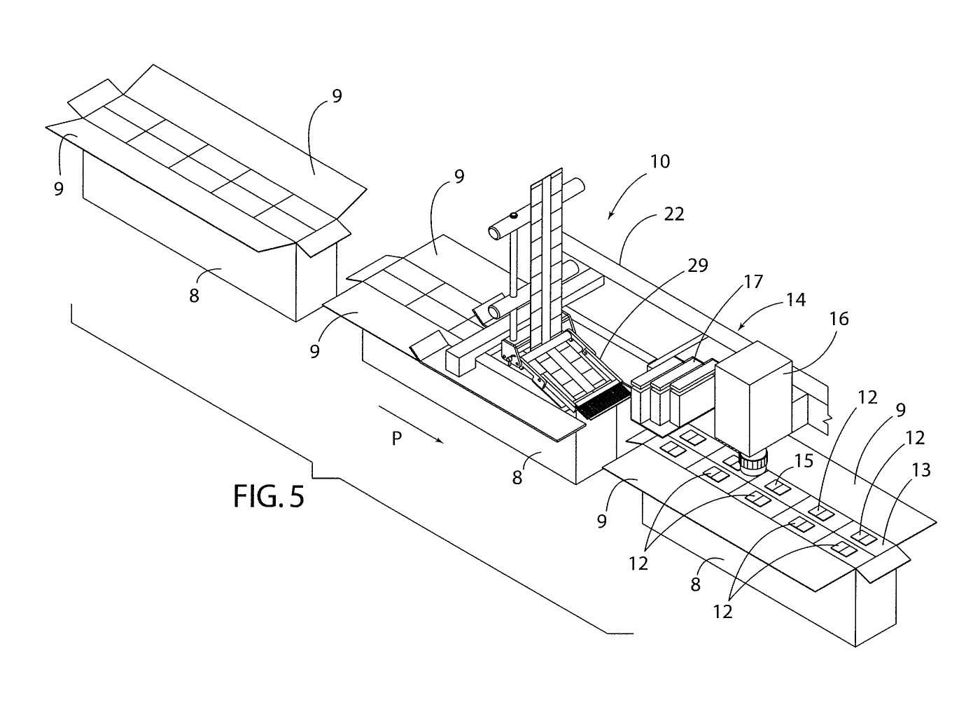

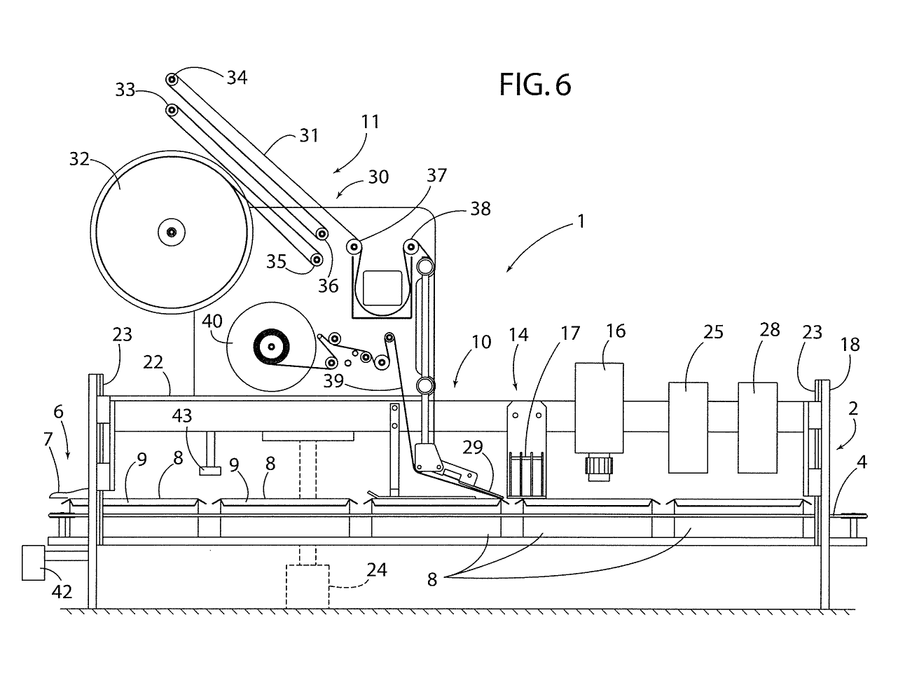

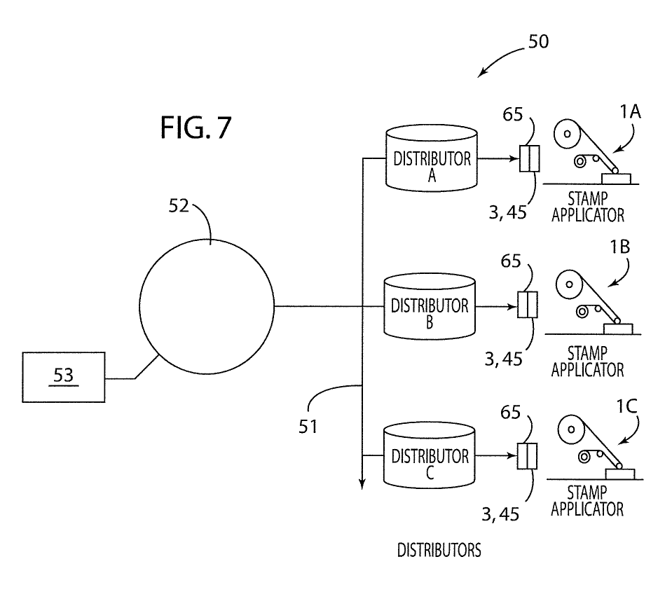

With reference to FIG. 1, a device or apparatus 1 for applying information such as tax stamp information to packages of cigarettes 13 includes a support structure 2 and a controller 3. As discussed in more detail below in connection with FIG. 7, the controller 3 may be connected to a network to receive tax stamp data from a remote location in digital form. The apparatus 1 includes a conveyor system 4 mounted to the support structure 2 for moving the cartons of cigarettes 8 along a path “P” (see also FIG. 5) defining a downstream direction. A loading station or system 5 receives cigarette cartons 8 that are moved along the conveyor system 4. An opening station 6 includes a “shoe” 7 (FIG. 6) that opens flaps 9 (FIG. 5) of cartons of cigarettes 8 moving along the conveyor system 4. As discussed in more detail below, apparatus 1 may include a scanner 42 positioned immediately upstream of opening shoe 7. Scanner 42 may be utilized to scan UPC bar code information printed on the cartons of cigarettes 8 by the manufacturers of the cigarettes. Apparatus 1 may include a label-applying station 10 downstream of the opening station 6 that includes an applicator 11 that applies labels 12 (see also FIG. 5) to the individual packs or packages of cigarettes 13 in the cartons of cigarettes 8. The apparatus 1 also includes a data-applying device such as a printer 17 of printing station 14. Printer 17 may be mounted to the support structure 2 downstream of the label-applying station 10. The printing station 14 is operably connected to the controller 3, and utilizes tax stamp data to print tax stamps 15 (FIG. 5) that may be in the form of 2D bar codes or other suitable format on the labels 12 on the individual packages or “packs” of cigarettes 13. A data-reading or scanning device or station may include an optical scanner 16 that is mounted to the support structure 2 downstream of the printing station 14. The optical scanner 16 reads/scans the tax stamps 15 printed on the labels 12 (FIG. 5) by the printing station 14, and generates data corresponding to the tax stamps 15. The controller 3 compares the data from the optical scanner 16 to the digital tax stamp data supplied to the apparatus 1 to determine if the data from the optical scanner 16 is the same or equivalent to the digital tax stamp data from the optical scanner 16 to thereby verify that the data has been applied. As described in more detail below, in addition to controller 3, the control system of apparatus 1 may include a computer 45 that is operably connected to the internet or other communication systems to receive tax stamp data from a remote source. Also, computer 45 may be operably connected to controller 3 to provide data to controller 3, and controller 45 may also be operably connected to other components of the apparatus 1. For example, computer 45 may be operably connected to printer 17, and provide tax stamp data to printer 17. Also, various devices or components of apparatus 1 such as the printer 17, optical scanner 16, and other components may have some processing capability, and therefore may comprise part of the control system of apparatus 1. Apparatus 1 may also include a glue-applying device 25 that applies adhesive/glue to the flaps of cartons 8, and a device 28 that closes the flaps of cartons 8 after glue is applied to the flaps. Gluing device 25 and closing device 28 are operably connected to controller 3. Gluing device 25 and closing device 28 together form a closing station that may be substantially similar to known closing stations. One example of a closing station is described in U.S. Pat. No. 6,878,222, the entire contents of which are incorporated by reference.

As described in more detail below, the tax stamp data (e.g. bar codes) may be in an encrypted format, and the data scanned by optical scanner 16 is decrypted by controller 3 utilizing a “key”. An example of a suitable encryption system is disclosed in U.S. Pat. No. 6,681,214. If the scanned/decrypted data is not verified (e.g. it does not match the tax stamp data received by computer 45 over communication system/network 51 (FIG. 7), controller 3 will not cause glue applying device 25 to apply glue and/or stop loading station 5, conveyor system 4 and/or generate a signal to the operator to thereby alert the operator to the problem. The operator may be directed to go to the outfeed conveyor 27/unloading station 26 to inspect the unglued carton to determine why it was not verified. The operator can then determine the cause of the problem, make corrections, and resume operations.

Referring again to FIG. 1, the loading station 5 of the apparatus 1 may be substantially similar to the loading station described in issued U.S. Pat. No. 7,437,860, entitled STAMP APPLICATOR WITH AUTOMATIC SIZING FEATURE, issued on Oct. 21, 2008, the entire contents of which are hereby incorporated by reference. As described in more detail in this patent, loading station 5 may include an infeed conveyor 19, a belt 20, and a measuring station 21 that determines the height and/or width of the cartons of cigarettes 8.

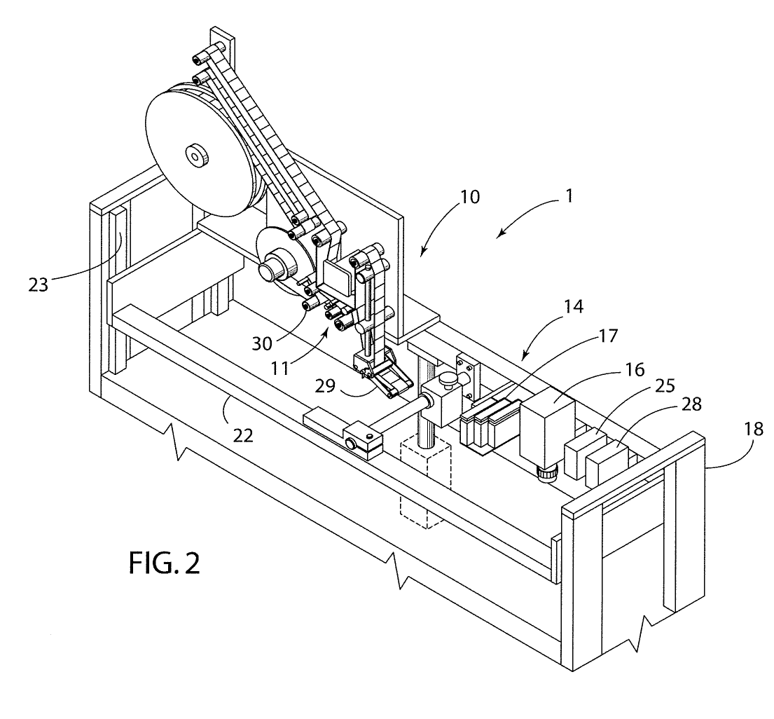

In the illustrated example, support structure 2 includes a primary support structure 18 and a moveable secondary support structure 22 (see also FIG. 6) that is moveably connected to the primary support structure 18 by linear guides 23 (FIG. 2). The size information concerning the cartons of cigarettes 8 may be utilized by the controller 3 to selectively actuate a powered actuator 24 (FIG. 6) to thereby shift the moveable secondary support structure 22 vertically relative to the primary support structure 18 to accommodate cartons of cigarettes 8 having different height dimensions. The shoe 7 (FIG. 6) of opening station 6, applicator 11 of label-applying station 10, printer 17 of printing station 14, optical scanner 16, gluing device 25, and closing device 28 may be mounted to the moveable secondary support structure 22, such that these components shift vertically upon actuation of powered actuator 24 to automatically accommodate cartons of cigarettes 8 having different heights. Apparatus 1 may also include an unloading station 26 having an outfeed conveyor 27 that is substantially similar to the unloading station described in more detail in U.S. Pat. No. 7,437,860. Also, conveyor system 4 may be adjustable to automatically accommodate for cartons of cigarettes 8 having different widths in substantially the same manner as described in more detail in U.S. Pat. No. 7,437,860.

Apparatus 1 may include a sensor 43 (FIG. 6) that measures the length of the cartons of cigarettes 8 as the cartons are moving between the opening station 6 and the peel tip 29. This enables the controller 3 to determine the position for each label 12, and the controller 3 can thereby actuate the printer 17 and the scanner 16 when the labels 12 are present for printing and scanning, respectively. In the illustrated example, sensor 43 comprises an emitter/detector positioned above the cartons 8, and a reflector positioned below the cartons 8. If the detector does not detect a reflected signal, this indicates a carton 8 is present. The shaft of the electric motor that powers the conveyor system 4 includes an encoder that provides controller 3 with position and/or velocity data that can be utilized to determine the velocity of cartons 8 as they move along conveyor system 4. This data and the data from sensor 43 can be utilized to determine the length of individual cartons 8.

Applicator 11 of label-applying station 10 includes a tape feed and a control device 30 (see also FIG. 6) of a known prior art design that feeds an elongated strip 31 from a roll 32 to the applicator 11. In the illustrated example, tape feed and control device 30 is a commercially available unit made by Label-Aire, Inc. of Fullerton, Calif. The tape feed and control device 30 includes a plurality of rollers 33-38 (FIG. 6) that facilitate feeding elongated strip 31 at the required feed rates. The elongated strip 31 (FIG. 6) generally includes a carrier strip comprising an elongated strip 39 of backing material having a non-stick first surface, with a plurality of labels 12 having adhesive on one side thereof disposed on the non-stick surface. The labels 12 may be blank as supplied on roll 32 (FIG. 6). Such labels are commercially available in rolls 32.

Applicator 11 also includes a “peel tip” 29 that receives strip 31 from tape feed and control device 30 and pairs of labels 12 from the non-stick strip 39 of material and adhesively applies the labels 12 to the packages of cigarettes 13. After the labels 12 (FIG. 5) are applied to the packages of cigarettes 13, a remaining strip 39 (FIG. 6) of backing material is wound onto a roll 40 for collection and eventual disposal. The peel tip 29 of applicator 11 may also be of a known design, such that the details of the peel tip 29 will not be further described in detail herein.

In contrast to heat transfer type stamping units, the tape feed and control device 30 can be configured to apply the labels 12 without slowing down or stopping the cartons of cigarettes 8 as the labels 12 are applied. Because the tape feed and control device 30 can be configured to apply the labels 12 without stopping the cartons 8, a greater number of cartons 8 can be processed by apparatus 1 in a given period of time.

According to another aspect of the present application, the individual packages of cigarettes 13 may be packaged such that the printer 17 prints the tax information directly onto the packages of cigarettes 13. In this case, apparatus 1 may be configured such that it does not include a label-applying station 10.

In the illustrating example, the printer 17 (FIG. 16) comprises a commercially available Hewlett-Packard cartridge system that is operably connected to the controller 3. However, it is readily apparent that a wide variety of printers could be utilized. In the illustrating example, the optical scanner 16 comprises an unattended scanning system having a decoding unit that decodes the 2D bar codes forming tax stamps 15 printed on the individual labels 12 (FIG. 5). In a preferred embodiment, the optical scanner 16 comprises a commercially available scanner available from Cognex Corporation of Natick, Mass. However, it will be apparent that other scanners/cameras may also be utilized.

As discussed above, apparatus 1 may print the bar code information on the blank labels 12 after the labels are applied to the individual packs of cigarettes. Alternately, the tax stamp information may be printed on the blank labels 12 by apparatus 1 immediately prior to applying the labels to the individual packs of cigarettes. Still further, 2D bar codes or other encrypted tax stamp information may be pre-printed on the labels 12 to form a roll 32 (FIG. 1) of pre-printed tax stamps. A roll 32 of pre-printed labels 12 with a 2D bar code or other encrypted tax code information can then be loaded into tape feed and control device 30, and the pre-printed labels 12 are then applied to the individual packs of cigarettes. The optical scanner 16 can then be utilized to scan the data, and the data can be decrypted utilizing a key as described above. If pre-printed labels/tax stamps are utilized, the tax stamp information is not distributed electronically to individual tax stamp applicators (FIG. 7) via a communication system/network 51. However, the scanned and decrypted information concerning the tax stamps can be processed and/or distributed over communication system/network 51 by controller 3 and/or computer 45.

In the illustrated example, tax stamps or tax indicia 15 are in a form commonly referred to as a “2D bar code.” This information is preferably in an encrypted form to provide for increased security, and the 2D bar code may be printed on labels 12. It will be understood that the data forming the tax indicia or stamps 15 may be in other forms such as other printed images, electromagnetic data, or other optical storage mediums and methods. For example, the label-applying station 10 could apply a magnetic strip or RFID tag to the individual packages of cigarettes 13. If a magnetic strip is utilized, the data-applying device could comprise a device that writes/records the tax stamp information on the magnetic strip, and the data-reading device could comprise a magnetic reader that would read the data from the magnetic strip. If, for example, an RFID tag is utilized, the information may be in a serialized form rather than being encrypted. In general, serialized information includes a number or other information that is applied to form a tax stamp. After the number or other indicia on a particular pack of cigarettes is scanned, a table is then utilized to determine what tax stamp information has been assigned to the number or other indicia. Thus, serialization type systems/technologies typically utilize a table or the like to determine what information has been assigned to a particular number or indicia. In contrast, if the tax stamp is applied in an encrypted format, the tax stamp information is present on the packages of cigarettes, and the key is utilized to decrypt the information into a useable form. Thus, encryption systems generally do not require use of a table or the like to determine what tax stamp information has been assigned to a particular number or other indicia. It will be understood that the apparatus and method of the present invention may be utilized to apply indicia other than tax stamp information to a variety of products, parts, components, and the like, other than packages of cigarettes.

With further reference to FIG. 7, a plurality of individual stamp applicator devices 1A-1C (or more) may be operably connected to form a tax stamp generation, distribution, and verification system 50. In the illustrating example, the system 50 may be operably connected to distributors A-C, each having a stamp applicator 1A-1C, respectively, that may be substantially similar to the apparatus 1 described in more detail above. The distributors A-C are connected to a system 52 via network or communication system 51. In the illustrated example, each distributor has a single stamp applicator device. However, each distributor could have two or more stamp applicators 1 connected to communications system 51. The network or communication system 51 may comprise the internet and/or other communication systems such as telephone systems, wireless communication systems such as cell phone systems or satellite communication systems, fiber optic or electrical communication systems, or the like. System 52 generates digital tax stamp information upon receipt of an order from one or more of the distributors A-C, and supplies the data to network 51. Preferably, the controllers 3 of each applicator 1A-1C include a firewall 65 to prevent unauthorized access to the controllers 3. In the illustrated example, system 52 comprises a commercially available product authentication system available from Authentix Corporation of Addison, Tex. System 52 may comprise a system and method according to U.S. Pat. No. 6,681,214, issued on Jan. 20, 2004, the entire contents of which are incorporated by reference. However, system 52 may also comprise other commercially available systems that generate digital tax stamp data, and distribute the data over a network or other communication system.

In use, distributors A, B, or C, place orders with a government tax agency 53 or other tax authority, and the system 52 provides tax stamp data in digital format to the distributor via network 51. The individual distributors A-C then print the digital tax stamp indicia on the packages of cigarettes utilizing the stamp applicators 1A-1C, and the cartons of cigarettes 8 are then shipped to retail outlets. Although the tax stamp data is preferably in an encrypted digital format, analog tax stamp data could also be generated and distributed over network/communication system 51, and applied to the blank labels/stamps 12. An analog printer and scanner may be used instead of digital printer 17 and digital optical scanner 16.

The scanner 42 (FIG. 6) may be operably connected to controller 3 and/or computer 45 and communication systems or network 51. Scanner 42 may operate in conjunction with a commercially available cigarette tax verification system that is available from Tax-Right, LLC of Hammonton, N.J. An example of such a verification system is described in U.S. Pat. No. 6,704,614. The scanner 42 may be configured to scan UPC bar code information printed on the cartons of cigarettes 8 by the manufacturer, and this information can be provided to the controller 3 and/or computer 45. The UPC information may include the brand of cigarettes, type of cigarettes, and other such information.

In use, an order concerning cigarettes to be stamped may be supplied to the controller 3 and/or computer 45. The order may include information concerning the number of each brand and type of cigarettes, and encrypted tax stamp information. The information from the UPC code that is scanned by scanner 42 can be compared to the information for a particular order. If the information from scanner 42 does not correspond to an order (e.g. the UPC information from scanner 42 is for a brand and/or type of cigarettes that is not present in the order), controller 3 generates a signal to stop the infeed conveyor 19, conveyor system 4, and/or other components. Similarly, if the UPC code information is unreadable by scanner 42, controller 3 may stop the conveyor system 4 and/or infeed conveyor 19 and/or other components. Still further, controller 3 may be configured to prevent operation if an operator attempts to begin work on an order prior to completion of a prior order.

Also, the UPC information concerning the brand and/or type of cigarettes generated by scanner 42 can be utilized to determine if the number and/or type of cigarettes sold in a given jurisdiction comply with the Master Settlement Agreement (“MSA”). In general, under the MSA cigarette companies provide estimates to local jurisdictions concerning the number of cigarettes sold within the particular jurisdiction, and the payments under the MSA are based on this estimate. According to another aspect of the present invention, the UPC/brand information for the cigarettes from scanner 42 can be utilized in conjunction with the tax stamp information for a specific jurisdiction to provide a report to the local government (e.g. state government) concerning the number of cigarettes stamped for a particular jurisdiction. This information can be compared to the estimates provided by the cigarette manufacturers to ensure that the payments under the MSA are accurate. Because the tax stamp information includes information concerning the jurisdiction (e.g. state) within which particular cigarettes will be sold, the combination of the tax stamp information and the UPC information from scanner 42 can be utilized to determine the number or cigarettes of a particular brand that are sold in a specific jurisdiction.

Referring again to FIG. 7, the tax stamp applicators 1A, 1B, 1C, etc. may be operably connected to a government tax agency 53 or other tax authority. The stamp applicators 1A, 1B, 1C, etc. may be operably connected to the government tax agency 53 such that the government agency 53 has at least some control over the operation of the individual stamp applicators 1A, 1B, 1C, etc. For example, if the government tax agency 53 determines that the UPC information from scanner 42 is not MSA compliant, the government tax agency 53 can shut down one or all of the applicators 1A, 1B, 1C, etc. Furthermore, if the government tax agency 53 determines that the tax stamp information applied by the apparatus 1 and scanned by optical scanner 16 does not comply with the requirements of the government tax agency 53, the government tax agency 53 can shut down the apparatus 1 and/or generate a signal to the operator utilizing controller 3 and/or computer 45.

The government tax agency 53 may also control the stamp applicators 1A, 1B, 1C, etc. utilizing approved manufacturers and/or brands criteria. For example, if only certain manufacturers are approved in a particular state, the UPC brand information printed on the cartons and scanned by scanner 42 may be compared to the approved list of manufacturers by the government tax agency 53. If a particular carton 8 of cigarettes entering apparatus 1 is not on the approved list, the government tax agency 53 can stop apparatus 1 and/or generate a signal to the operator or other entity.

The tax stamp apparatus 1 (FIG. 1) of and method of the present invention provide a way to create a tax stamp at the time it is applied to the individual cartons of cigarettes. In this way, potential problems (e.g. physical security) associated with pre-printing tax stamps can be eliminated. Furthermore, the apparatus 1 provides verification that the digital tax stamp data has actually been printed on the individual packages of cigarettes utilizing the scanner. In this way, immediate verification that the tax stamps have been properly printed can be provided immediately and distributed by the network. Also, unique codes including a relatively large amount of data may be included on each stamp. For example, each stamp may include information concerning the distributor's identification, date and time of application of the stamp, brand and type of cigarettes, stamp value, and cigarette pack denomination. Also, the tax stamp information may be in an encoded or encrypted format to prevent unauthorized access to the data. If the tax stamp data applied in the bar code is encrypted. The system thereby improves improved security, and substantially eliminates the possibility of forging tax stamps, theft of tax stamps, or other such security problems.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. An apparatus for applying tax indicia to packages of cigarettes, the apparatus comprising:
a support structure;
a control system configured to receive tax stamp data;
a conveyor system mounted to the support structure for moving cartons of cigarettes along a path defining a downstream direction;
a loading system configured to receive cartons of cigarettes to be moved along the conveyor system;
an opening station downstream of the loading station, the opening station having an opening member shaped to open flaps of cartons of cigarettes moving along the conveyor system to provide access to packages of cigarettes in the cartons;
a label-applying station downstream of the opening station, the label-applying station including an applicator that applies labels to packages of cigarettes;
a printing station mounted to the support structure downstream of the label-applying station, the printing station being operably connected to the control system and utilizing tax data to print tax indicia on packages of cigarettes corresponding to the tax data;
an optical scanner mounted to the support structure downstream of the printing station, wherein the optical scanner reads the tax indicia printed on labels by the printing station and generates data corresponding to the tax indicia; and wherein:
the data generated by the optical scanner is evaluated according to predefined criteria to determine if the predefined criterion is satisfied.

2. The apparatus of claim 1, wherein:
the control system receives tax information from a remote source.

3. The apparatus of claim 1, wherein:
the control system is connected to a worldwide network of computers and receives the tax information from a remote source connected to the worldwide network.

4. The apparatus of claim 3, wherein:
the remote source provides tax information to the apparatus in an encrypted format.

5. The apparatus of claim 1, wherein:
the control system includes a controller that is operably connected to at least one of the conveyor system, the loading system, the label-applying station, the printing station, and the optical scanner, the control system further including a computer that is operably connected to at least the controller.

6. The apparatus of claim 1, wherein:
the control system alters the operation of the apparatus if the data generated by the optical scanner does not satisfy the predefined criteria.

7. The apparatus of claim 6, including:
a gluing station including a gluing device configured to apply glue to flaps of cartons of cigarettes after the flaps have been opened by the opening station;
a closing device configured to close flaps of cartons of cigarettes after the cartons pass through the gluing device; and wherein:
the control system causes the gluing station to not apply glue to flaps of a specific carton of cigarettes if the data generated by the optical scanner for tax indicia of a specific carton of cigarettes does not satisfy the predefined criteria.

8. The apparatus of claim 1, wherein:
the predefined criteria include tax stamp data received by the control system, and wherein the data generated by the optical scanner is compared to tax data received by the control system.

9. The apparatus of claim 8, wherein:
the control system generates a signal if the data generated by the optical scanner for a selected package of cigarettes is significantly different than the tax data received by the control system for the selected package of cigarettes.

10. The apparatus of claim 1, wherein:
the apparatus is operably connected to a remote tax authority, and wherein information relating to the data generated by the optical scanner is transferred to the remote tax authority.

11. The apparatus of claim 10, wherein:
the remote tax authority generates a control signal that is received by the control system of the apparatus whereby the remote tax authority has at least some control over the operation of the apparatus.

12. The apparatus of claim 11, wherein:
the remote tax authority receives at least some of the data generated by the optical scanner.

13. The apparatus of claim 11, wherein:
the control signal generated by the remote tax authority causes the apparatus to stop printing tax indicia on packages of cigarettes.

14. The apparatus of claim 1, wherein:
the control system includes an operating mode that causes the conveyor system to move cartons of cigarettes through the label-applying station without stopping unless predefined operating criteria are present.

15. The apparatus of claim 14, wherein:
the conveyor system moves cartons of cigarettes through the opening station, the label-applying station, and the printing station at a substantially constant velocity.

16. The apparatus of claim 15, wherein:
the control system causes the conveyor system to stop if a predefined operating criteria occurs.

17. The apparatus of claim 1, wherein:
the apparatus includes a scanner configured to read bar code information on cartons of cigarettes processed by the apparatus, and wherein the bar code includes information concerning the identity of manufacturers of cartons of cigarettes.

18. The apparatus of claim 17, wherein:
the apparatus is operably connected to a remote tax authority, and information concerning the identity of manufacturers of cartons of cigarettes is supplied to the remote tax authority.

19. The apparatus of claim 18, wherein:
the remote tax authority is operably connected to the control system, and wherein the remote tax authority can generate a control signal to the control system and control at least some aspects of the operation of the apparatus.

20. The apparatus of claim 19, wherein:
the remote tax authority can generate a signal to the control system of the apparatus to substantially halt operation of the apparatus.

21. The apparatus of claim 17, wherein:
the scanner is operably connected to the control system, and wherein the control system receives order information including the identity of manufacturers of cigarettes in the order, and wherein the control system compares information from the scanner to the order information.

22. The apparatus of claim 21, wherein:
the control system alters control of the apparatus if information from the scanner does not match the order information.

23. The apparatus of claim 1, wherein:
the support structure includes a primary structure and a secondary structure moveably mounted to the primary support structure to provide vertical movement of the secondary structure relative to the primary support structure; and including:
a powered actuator operably interconnecting the primary structure and the secondary structure and selectively shifting the secondary structure relative to the primary structure; and wherein:
the printing station includes a printer mounted to the secondary structure; and including:
the optical scanner is mounted to the secondary structure.

24. The apparatus of claim 23, including:
a measuring station upstream of the opening station that measures at least a height of packages of cigarettes; and wherein:
the powered actuator and the measuring station are operably connected to the controller, and the controller actuates the powered actuator to adjust a vertical position of the secondary support structure based, at least in part, on the height of cartons of cigarettes loaded into the apparatus.

25. The apparatus of claim 1, wherein:
the conveyor system includes at least a first powered conveyor and a second powered conveyor, wherein the first powered conveyor defines an upstream end, and the second powered conveyor defines a downstream end directly adjacent the upstream end of the first powered conveyor, such that packages of cigarettes can be transferred from the first powered actuator to the second powered conveyor, and wherein:
the controller is configured to actuate the first and second powered conveyors at the same time, and to actuate only the second powered conveyor.

26. The apparatus of claim 1, wherein:
the tax stamp indicia is printed to form a two dimensional bar code.

27. The apparatus of claim 1, wherein:
a unique tax stamp indicia is printed on each package of cigarettes.

28. An apparatus for applying tax indicia to packages of cigarettes, the apparatus comprising:
a conveyor system that moves cartons of cigarettes along a path defining a downstream direction;
a loading station configured to receive cartons of cigarettes to be moved along the conveyor system;
a label-applying station downstream of the loading station, the label-applying station including an applicator that removes labels from a carrier strip and adhesively applies the labels to packages of cigarettes in the cartons;
a printing station downstream of the label-applying station, the printing station including a printer that prints tax indicia on the labels that have been applied to the packages of cigarettes;
an optical device downstream of the printing station that generates data corresponding to the tax indicia printed on the labels.

29. The apparatus of claim 28, including:
a control system that determines if the data generated by the optical device satisfies predetermined criteria.

30. The apparatus of claim 29, wherein:
the control system is connected to a communications network, and receives tax information from a remote location.

31. The apparatus of claim 28, wherein:
the conveyor system includes a main conveyor that moves cartons of cigarettes in the downstream direction;
the loading station includes an infeed conveyor that moves cartons of cigarettes in a direction transverse to the downstream direction towards the main conveyor; and including:
an unloading station downstream of the optical scanner and including a discharge conveyor that moves cartons of cigarettes in a direction transverse of the downstream direction away from the main conveyor.

32. The apparatus of claim 28, wherein:
the tax indicia printed on the labels comprises two-dimensional bar codes.

33. A method of applying tax indicia to packages of cigarettes, the method comprising:
generating cigarette tax information;
supplying cigarette tax information to an apparatus configured to apply the tax information to packages of cigarettes;
moving packages of cigarettes through the apparatus along a conveyor;
applying labels to packages of cigarettes;
applying tax indicia on the labels after the labels have been applied to packages of cigarettes;
scanning the tax indicia to generate scanned tax information.

34. The method of claim 33, including:
comparing the scanned tax information to the cigarette tax information supplied to the apparatus.

35. The method of claim 34, including:
generating a signal if the scanned tax information is sufficiently different from the cigarette tax information supplied to the apparatus such that the differences do not meet predefined criteria.

36. The method of claim 34, wherein:
the tax indicia printed on the labels comprises a two-dimensional bar code.

37. The method of claim 34, wherein:
the scanned tax information is decoded prior to comparing it to the tax information supplied to the apparatus.

38. A method of applying tax information to packages of cigarettes, the method comprising:
providing an apparatus having a conveyor, an applicator and a scanner;
generating tax information for packages of cigarettes;
encrypting the tax information;
transferring encrypted tax information to a medium in the form of encrypted bar code sections, wherein each section of encrypted bar code comprises tax information for a package of cigarettes;
loading cartons of cigarettes into the apparatus;
applying the medium including the encrypted bar code sections to individual packages of cigarettes after the individual packages of cigarettes are loaded into the apparatus;
utilizing the scanner to scan the encrypted bar code sections after the encrypted bar code sections are applied to individual packages of cigarettes to form detected tax information;
decrypting the detected tax information; and
comparing the decrypted tax information to the tax information utilized to form the encrypted tax information.

39. The method of claim 38, wherein:
the medium comprises an elongated flexible strip.

40. The method of claim 39, wherein:
the medium further comprises an elongated strip of flexible material having a low adhesion surface on a first side of the strip of flexible material, and a plurality of individual sheets of material having a layer of adhesive disposed on a lower side thereof releasably securing the individual sheets to the low adhesion surface of the strip of flexible material.

41. The method of claim 40, including:
forming the elongated strip of flexible material into a roll after the encrypted tax information is transferred to the medium;
installing the roll in the apparatus.

42. The method of claim 38, wherein:
the encrypted tax information is transferred by printing.

43. The method of claim 38, wherein:
the encrypted tax information is printed on the medium in the form of a 2D bar code.

44. The method of claim 38, including:
transferring detected tax information from the apparatus to a remote tax authority.

45. An apparatus for applying tax stamp information to packages of cigarettes, the apparatus comprising:
a conveyor system;
an opening station positioned adjacent the conveyor system for opening cartons of cigarettes to provide access to individual packages of cigarettes in the cartons;
a device configured to apply tax stamp information to packages of cigarettes after the cartons of cigarettes are opened at the opening station;
a scanner configured to read bar codes on the cartons of cigarettes to generate detected information concerning an identity of a manufacturer of cartons of cigarettes; and
a control system configured to receive order information concerning an identity of a manufacturer of cigarettes in the order information, and wherein the control system compares the order information to the detected information and generates a signal if identities of the manufacturers in the order information does not match the identities of the manufacturers of the detected information.

46. The apparatus of claim 45, wherein:
the apparatus is operably connected to a tax authority that is remote from the apparatus, and wherein at least some of the detected information is transferred to the remote tax authority.

47. The apparatus of claim 45, wherein:
the tax stamp information includes the jurisdiction of a tax authority; and
the control system associates the detected information with the jurisdiction for cartons of cigarettes and thereby generates data that can be utilized to determine how many cartons of cigarettes manufactured by a selected manufacturer have been processed by the apparatus.
